(19) United States
(12) Patent Application Publication
(10) Pub. No.: US 2018/0211827 A1
(43) Pub. Date: Jul. 26, 2018

(54) METHOD FOR OPERATING A XENON EXCIMER LAMP AND LAMP SYSTEM COMPRISING AN EXCIMER LAMP

(71) Applicant: Heraeus Noblelight GmbH, Hanau (DE)

(72) Inventors: Erich ARNOLD, Mainz (DE); Franz-Josef SCHILLING, Freigericht (DE)

(21) Appl. No.: 15/743,573

(22) PCT Filed: Jun. 16, 2016
(86) PCT No.: PCT/EP2016/063848

§ 371 Date: Jan. 10, 2018

(30) Foreign Application Priority Data
Jul. 13, 2015 (DE) 10 2015 111 284.1

(51) Int. Cl. H01J 61/52; H01J 65/04; H01J 61/12

(52) U.S. Cl. CPC H01J 61/52; H01J 61/12; H01J 65/046

(57) ABSTRACT

Methods for operating a xenon excimer lamp, including an exit window made of quartz glass, are provided. The methods include the steps of: (a) operating the xenon excimer lamp at an irradiation intensity of more than 80 mW/cm²; and (b) temperature-controlling the xenon excimer lamp to an operating temperature. According to aspects of the invention, methods for operating a xenon excimer lamp at an irradiation intensity of more than 80 mW/cm² are provided that enable a long service life of the xenon excimer lamp. According to aspects of the invention, the temperature of the xenon excimer lamp is controlled to an operating temperature in the range of 181° C. to 199° C.

### CROSS REFERENCE TO RELATED APPLICATIONS

This application is a U.S. National Phase filing of international patent application number PCT/EP2016/063848 filed Jun. 16, 2016 that claims the priority of German patent application number 102015111284.1 filed Jul. 13, 2015. The disclosures of these applications are hereby incorporated by reference in their entirety.

### FIELD

This invention relates to lamp systems, in particular lamp systems including xenon excimer lamps and methods of operating the same.

### BACKGROUND

Known excimer lamps comprise a closed discharge vessel with a discharge space. The discharge space is filled with a filling gas that is suitable for the emission of excimer radiation. The discharge vessel further includes an exit window made of quartz glass for the radiation generated by the excimer lamp.

Excimers (“excited dimers”) are short-lived molecules that exist only in the excited state and emit radiation in a narrow spectral range when they return to their non-bound ground state. The wavelength of the radiation emitted by the excimer lamp depends on the filling gas. Excimer lamps with a xenon filling (xenon excimer lamps) mainly emit vacuum ultraviolet radiation (VUV radiation) at a wavelength of approximately 172 nm.

The irradiation intensity reached by a xenon excimer lamp during operation depends on the electrical power at which it is operated. In this context, there is a basically linear correlation between the power consumption and the irradiation intensity. FIG. 1 shows, in exemplary manner, a diagram showing the radiation intensity of a xenon excimer lamp as a function of power consumption.

However, it is not possible to increase the irradiation intensity of excimer lamps to just any level by increasing the operating power. This is mainly due to a material property of the quartz glass, namely its temperature-dependent transmission. This can be described according to Urbach by an empirical formula; which is also called the “Urbach tail”. The Urbach tail defines a lower limit for the transmission of photons of a wavelength A; it is common to all quartz classes regardless of whether the quartz glass was manufactured from synthetically-made or naturally-occurring starting materials.

It is known that the level of the Urbach tail is temperature-dependent and shifts towards longer wavelengths with increasing temperature of the quartz glass (also refer to FIG. 3). The shift of the Urbach tail has an impact on the radiation spectrum emitted by the excimer lamp. Xenon excimer lamps do not emit monochromatic radiation, but rather radiation with a peak at a wavelength of 172 nm and a full peak width at half-maximum of approximately 15 nm (FWHM). The shift of the Urbach tail leads to especially the high energy portion of the emitted radiation being absorbed increasingly with increasing temperature of the quartz glass of a lamp.

Therefore, usually only irradiation intensities of less than 80 mW/cm² on their quartz glass surface can be attained with conventional excimer lamps. The useful life of these excimer lamps usually is several thousand hours.

In order to be able to persistently operate a xenon excimer lamp at a high irradiation intensity, in particular of more than 80 mW/cm² (so-called high-performance excimer lamps), it is necessary to actively cool the lamp tube, for example through forced cooling by means of a fan or by reinforced heat conduction via the rear-side lamp surface.

An excimer lamp that is temperature-controlled to a given operating temperature is known, for example, from the doctoral thesis of M. Paravia (Para via, M; 2010; Effizienter Betrieb von Xenon-Excimer-Entladungen bei hoher Leistungsdichte [doctoral thesis]; KIT Karlsruhe; pages 48-50). In this document, a range of 20° C.≤T≤180° C. is discussed as the possible temperature range of the operating temperature T to be adjusted.

However, it has been evident that xenon excimer lamps operated at high power and a low operating temperature often have a short useful life, mostly of less than 1000 hours. Thus, it would be desirable to provide improved lamp systems including xenon excimer lamps, and methods of operating the same.

### SUMMARY

According to an exemplary embodiment of the invention, a method of operating a xenon excimer lamp including an exit window made of quartz glass is provided. The method includes the steps of: (a) operating the xenon excimer lamp at an irradiation intensity of more than 80 mW/cm²; and (b) temperature-controlling the xenon excimer lamp to an operating temperature.

Moreover, aspects of the invention relate to a lamp system including a xenon excimer lamp. The xenon excimer lamp includes an exit window made of quartz glass, and a temperature control unit for adjusting an operating temperature of the xenon excimer lamp. The xenon excimer lamp is designed for operation at an irradiation intensity of more than 80 W/cm².

Exemplary lamp systems according to the invention include an excimer lamp with a xenon-containing filling gas that is designed to emit high-energy radiation at a wavelength of approximately 172 nm. Such lamp systems may be used, for example, for decomposition of organic material, for cleaning and activation of surfaces or in CVD processes, for example, in the semiconductor or display manufacturing industry.

### BRIEF DESCRIPTION OF THE DRAWINGS

The invention is best understood from the following detailed description when read in connection with the accompanying drawings. It is emphasized that, according to common practice, the various features of the drawings are not to scale. On the contrary, the dimensions of the various features are arbitrarily expanded or reduced for clarity. Included in the drawings are the following figures:

FIG. 1 shows a diagram showing the VUV irradiation intensity [mW/cm²] of a xenon excimer lamp as a function of the electrical power consumption [W] right after the start;

FIG. 2 shows a diagram, in which the VUV radiation intensity as a function of the electrical power consumption right after a start up of the lamp is contrasted to the VUV radiation intensity after burn-in of the xenon excimer lamp;

FIG. 3 shows a diagram, in which the shift of the absorption edge (Urbach tail) of highly pure, synthetic quartz glass as a function of the temperature is depicted:

FIG. 4 shows a spectrum of the radiation emitted by the xenon excimer lamp right after ignition of the lamp;

FIG. 5 shows a spectrum of a xenon excimer lamp right after ignition and after burn-in for comparison (without cooling);

FIG. 6 shows a diagram in which the relative VUV intensity [%] of a xenon excimer lamp is shown as a function of the burn-in time of the lamp (with cooling (measuring curve 20)), without cooling (measuring curve 10));

FIG. 7 shows a transmission spectrum of highly pure, synthetic quartz glass after extended irradiation; and

FIG. 8 shows transmission spectra of highly pure, synthetic quartz glass after irradiation at a quartz glass temperature of 20° C. and 160° C.

### DETAIL DESCRIPTION

Aspects of the invention is based on the object to devise a method for operating a xenon excimer lamp at a high irradiation intensity of more than 80 mW/cm² while facilitating a long useful life of the xenon excimer lamp.

Moreover, aspects of the invention are based on the object to devise a lamp system comprising an excimer lamp that comprises a long useful life.

According to certain exemplary embodiments of the invention, the object specified above is solved based on a method of the type specified above in that the excimer lamp is temperature-controlled to an operating temperature in the range of 181° C. to 199° C.

Aspects of the invention are based on finding that the shortened useful life of high-performance excimer lamps operated at a high irradiation intensity and low quartz glass temperature is caused by the formation of defect centres in the quartz glass. These can arise due to the interaction of the plasma in the discharge space with the quartz glass.

The plasma generated in the discharge space during the operation of excimer lamps contains, in particular, electrons and ions, which, due to their charge, can be accelerated appropriately in the E-field of the excimer lamp such that they impinge with high energy on the inner quartz glass surface of the excimer lamp. This leads to damage in the quartz glass that favours the build-up of defect centres with characteristic absorption bands, in particular in the ultraviolet range. On the other hand, high-energy photons can also generate radiation damage in the quartz glass. These defect centres are also called “colour centres”. The absorption bands of the defect centres can impair the transmission of effective radiation with wavelengths of approximately 172 nm.

Accordingly, the manifestation of so-called E′ centres (Si°) are observed in all types of quartz glass. The reaction

Si—H+(hv,e−,ion)>Si°+H

produces an E′ centre with a broad absorption band for UV radiation with its peak at 215 nm. Analogously, so-called NBOH defect centres are produced in OH-containing quartz glass by the reaction,

Si—OH+(hv,e−,ion)>SiO°+H,

whereby, as before, a defect centre with a broad absorption band with a peak at 265 nm is produced.

The manifestation of defect centres is a function of the temperature of the quartz glass. Especially at low temperatures of approximately 20° C., increased formation of these centres is observed.

To reduce the emergence of defect centres and to enable regression of defect centres that have emerged, it is necessary to keep to a minimum quartz glass temperature, in particular in order to provide the activation energy for regression.

It has been evident that an optimal quartz glass temperature for the regression of emerged defect centres is in the range of 181° C. to 199° C. A temperature being in this range is suitable, on the one hand, for counteracting defect centre-related radiation losses and, on the other hand, is low enough to keep the influence of the Urbach tail on the xenon excimer spectrum low. A quartz glass temperature of 200° C. or more is associated with reduced transmission of the quartz glass. Only little regression of defect centres is observed at temperatures below 181° C.

An exemplary optimal temperature range for operation of xenon high-performance excimer lamps is therefore in the range specified above. In certain applications, it has shown to be advantageous for the operating temperature to be as close as possible to the upper limit of 199° C. Advantageously, the excimer lamp is temperature-controlled to an operating temperature in the range of 191° C. to 199° C., particularly preferably to a temperature of 195° C. to 199° C. By this means, xenon excimer lamps can be operated with VUV irradiation intensities of more than 80 mW/cm², in particular in an irradiation intensity range of 85 mW/cm² to 125 mW/cm², for a period of time of more than 1000 hours.

The radiation intensity is a measure of the energy of the radiation emitted by the excimer lamp onto a surface that is at a distance from the excimer lamp. The irradiation intensities specified in the preceding section and hereinafter all refer to a distance of 1 cm from the surface of the exit window.

The exit window is the region of the discharge vessel, which is designed to emit radiation. It comprises good transmission for ultraviolet radiation—especially compared to other regions of the discharge vessel—and is manufactured from quartz glass. The exit window can take a variety of shapes, for example, it can be planar, curved, round or designed like an annular gap.

An exemplary optimal operating temperature in the range of 181° C. to 199° C. is to be adjusted, mainly, on the exit window. The larger the fraction of exit window in which the temperature is within this range, the better the desired effect is attained.

It has been proven expedient to provide, for temperature-control of the excimer lamp, a control unit that determines an actual value of the operating temperature, compares the actual value of the operating temperature to a nominal value of the operating temperature, and issues a control signal to the temperature control unit in order to adjust the cooling/heating power of the temperature control unit.

A control unit contributes to the excimer lamp operating temperature being as even as possible to allow the formation of defect centres to be counteracted effectively.

Advantageously, the temperature control according to process step (b) may take place by means of a fan.

The adjustment of the temperature of the exit window of an excimer lamp can be implemented easily and inexpensively using a fan. Moreover, the blower power of a fan is easy to adjust. By this means, the amount of fluid moved by the fan can be quickly adapted to the current ambient temperature.

It has proven to be expedient for the excimer lamp to comprise a lamp tube including the exit window that limits a discharge space, and includes a rear-side lamp tube surface opposite from the exit window, and for the temperature control according to process step (b) to take place by means of a fluid that is guided over the rear-side lamp tube surface.

For many fields of application, the excimer radiation is directed at a pre-determined irradiation area. Accordingly, excimer lamps often include an exit window in the form of an illuminated lamp tube section. In order to direct the excimer radiation onto a certain area outside of the discharge vessel, the discharge vessel includes, in addition to an illuminated lamp tube section, a rear-side section that shows lower transmission. Frequently, a reflector layer reflecting the radiation that is directed toward the rear-side lamp tube surface is also provided in this area.

Although, basically, the temperature of the exit window is decisive for certain operating methods according to the invention, the exit window cannot be cooled directly with a fluid. This would be disadvantageous due to additional loss of radiation caused by the absorption of portions of the radiation by the fluid. Temperature-controlling the rear-side lamp tube surface attains an indirect temperature control of the exit window.

Preferably, the fluid is water. Water is suitable for heat transport and, in addition, is usually available easily and in sufficient quantities.

According to certain exemplary embodiments of the invention, a method for operating a xenon excimer lamp is provided to involve an exit window and an exit window thickness in the range of 1 mm to 2 mm.

The thickness of the exit window has an influence on the emergence and regression of defect centres. Especially in the case of very thick exit windows, a temperature gradient across the thickness of the exit window may be produced. If the temperature is too low in a region of the exit window, defect centres impairing the transmission of radiation and the useful life of the excimer lamp may be produced in this site. Exit windows with a thickness of more than 2 mm are increasingly associated with defect centres. Exit windows with a thickness of less than 1 mm are fragile, which makes them difficult to handle.

Referring to the lamp system, the object specified above is solved according to the invention based on a lamp system of the type specified above in that the temperature control unit is designed accordingly such that the excimer lamp is temperature-controlled to an operating temperature in the range of 181° C. to 199° C.

A lamp system having a temperature control unit that is designed in this way is suitable for implementation of the method according to the invention. Keeping to the operating temperature range specified above enables, on the one hand, operation of the excimer lamp at high power of more than 80 mW/cm² and, on the other hand, enables a long service life.

In the following, the invention is described in more detail based on exemplary embodiments and reference examples and eight figures.

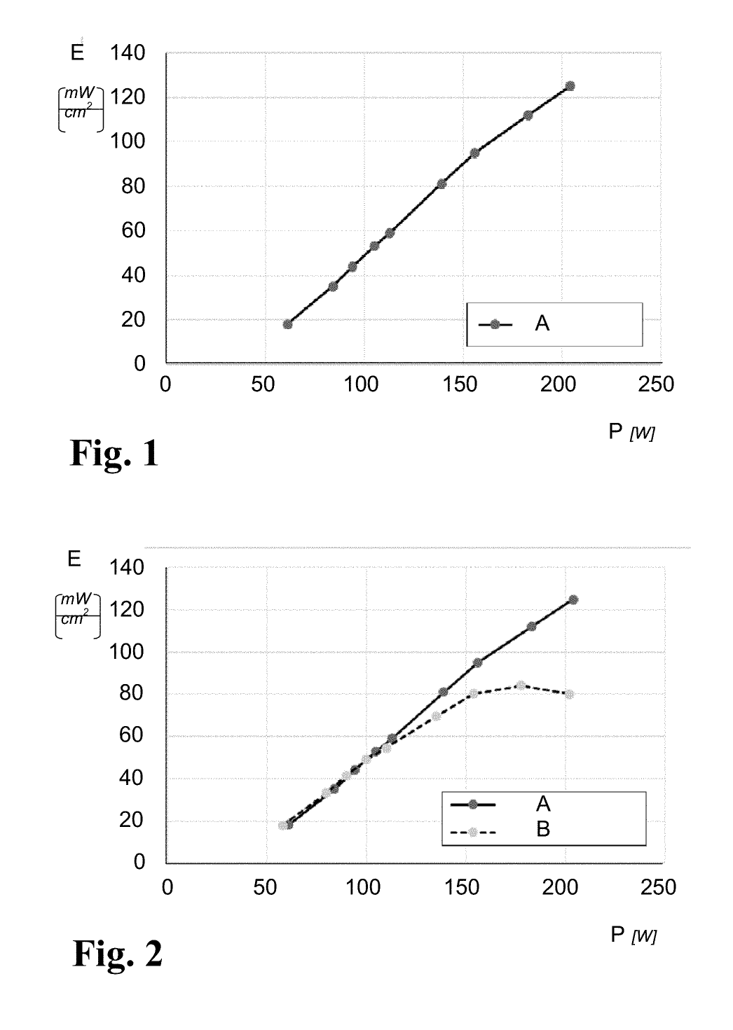

The diagram of FIG. 1 shows, in an exemplary manner, the VUV irradiation intensity E of a planar xenon excimer lamp as a function of its electrical power consumption P.

A planar excimer lamp whose discharge space is bordered by two quartz glass plates was used for the measurement. The quartz glass plates of the lamp are fused to each other on their edges by melting; they are arranged parallel with respect to each other and have a distance of 1 mm from each other. The wall thickness of the quartz glass plates is 1 mm. The illuminated area of the excimer lamp is 64 cm² in size.

The excimer lamp was operated appropriately in a nitrogen atmosphere such that it was cooled by natural convection only. The VUV irradiation intensity was measured right after ignition of the excimer lamp, and this was done at a distance of 1 cm from the surface of an excimer lamp.

Measuring curve A shows that the radiation intensity increases nearly linearly with an increase of the electrical power consumption of the excimer lamp over a wide range of power.

However, right after ignition, the quartz glass surface is still at room temperature since the excimer lamp reaches its operating temperature only after a certain time of operation.

FIG. 2 shows the results of measurement of the VUV radiation intensity after the excimer lamp has reached its operating temperature (measuring curve B). Measuring curve B is indicated by a dashed line. For easier comparison, the measuring results from FIG. 1 obtained right after start-up of the lamp (measuring curve A, indicated by full line) are also depicted in FIG. 2.

Up to an operating power of 115 W, measuring curve B, measured after the operating temperature was reached (burn-in), did not differ from measuring curve A, which was measured right after start-up of the lamp. However, at an operating power of more than 115 W, in particular of more than 140 W, irradiation intensities at best of approximately 80 mW/cm² are attained with a burnt-in excimer lamp.

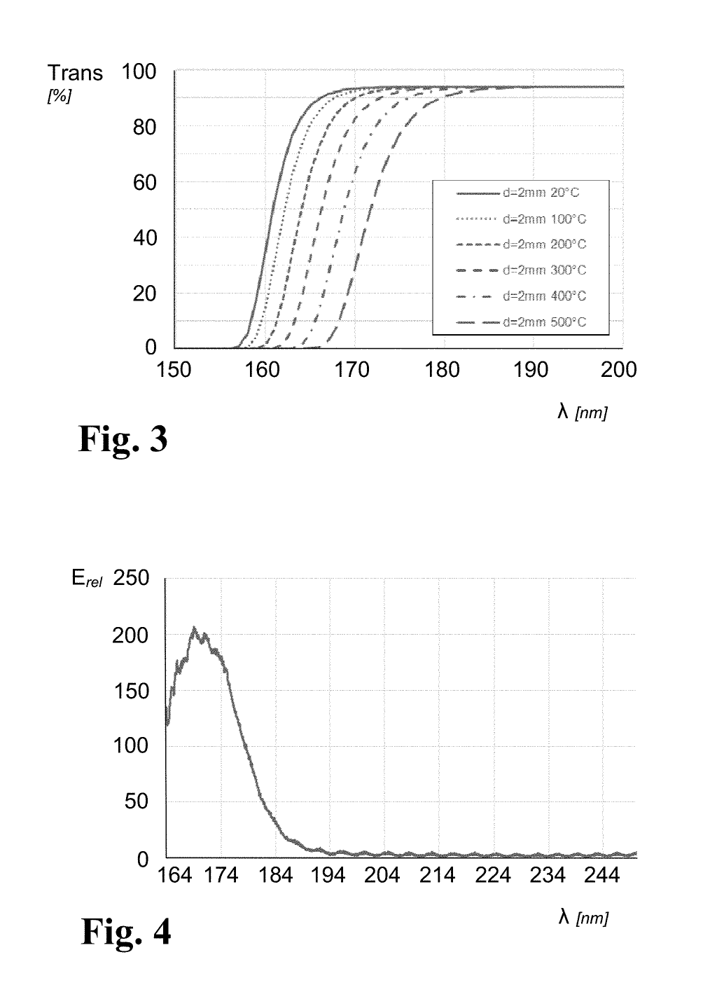

FIG. 3 shows the transmission of highly pure, synthetic quartz glass with a thickness of 2 mm as a function of the wavelength for various quartz glass temperatures (20° C.; 100° C.; 200° C.; 300° C.; 400° C.; 500° C.).

All transmission curves show an S-shaped profile independent of the temperature. These transmission curves represent an absorption edge that is also called “Urbach tail”. It is evident from FIG. 3 that the absorption edge is temperature-dependent and shifts toward longer wavelengths with increasing quartz glass temperature.

FIG. 4 shows the emission spectrum of an excimer lamp right after ignition, of the type known from the explanations provided referring to FIG. 1. The spectrum mainly includes radiation portions in the VUV range. The peak is at approximately 172 nm with a FWHM (full width at half maximum) of 15 nm.

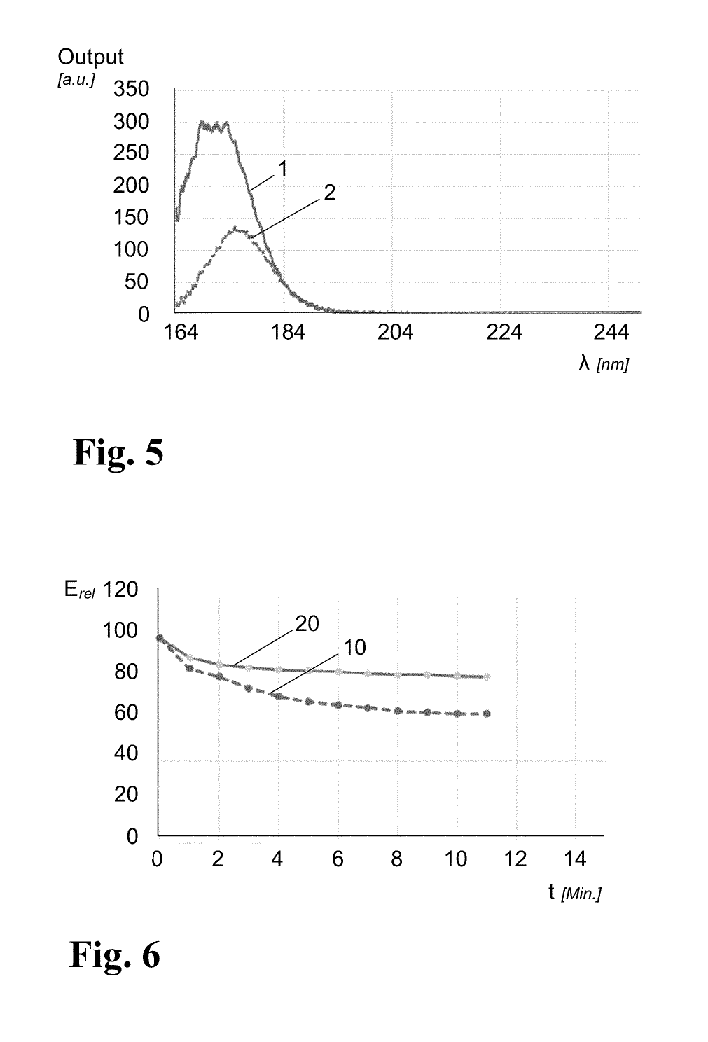

FIG. 5 shows a comparison of the emission spectra of an excimer lamp before (1) and after (2) burn-in. During the burn-in, the temperature of the quartz glass of the exit window increases and there is a shift of the absorption edge (Urbach tail) towards longer wavelengths. Due to the shift of the absorption edge, the high-energy portions of the radiation are absorbed referentially.

FIG. 6 shows the influence of cooling on the relative VUV intensity [%] of a xenon excimer lamp.

A planar excimer lamp was used as the excimer lamp. The lamp includes two plates made of synthetic quartz glass (10×10 cm²) each 1 mm in thickness, that are kept at a distance of 1 mm from each other and are fused to each other by melting on the sides such as to be vacuum-tight. The space between the plates thus generated is filled by several hundred mbar xenon. Structures, which are electrically conductive, thin (200 mm), lattice-like, applied by photolithography, and in contact with the external surfaces of the excimer lamp, form the electrodes, which, in common manner, generate a dielectric gas discharge in the excimer lamp by means of a high-frequency alternating electrical field. The active photon-emitting area is 64 cm² in size. The electrical power of the system including a ballast unit and excimer lamp taken up from the mains is maximally 240 W and can be dimmed.

The excimer lamp was operated in a chamber that is flooded with nitrogen and has a fan installed in it. The fan can be switched on or off. It optionally generates an additional cooling flow of nitrogen that lowers the temperature of the front side of the excimer lamp.

Measuring curve 10 shows the relative VUV intensity Erel of the radiation emitted by an excimer lamp with the cooling switched off. It is evident from the profile of measuring curve 10 that the VUV intensity Erel decreases with [increasing] operating time and increasing operating temperature.

Measuring curve 20 shows a curve for an excimer lamp that is continuously cooled by the additional cooling flow. By this means, a higher VUV irradiation intensity Erel can be maintained over time.

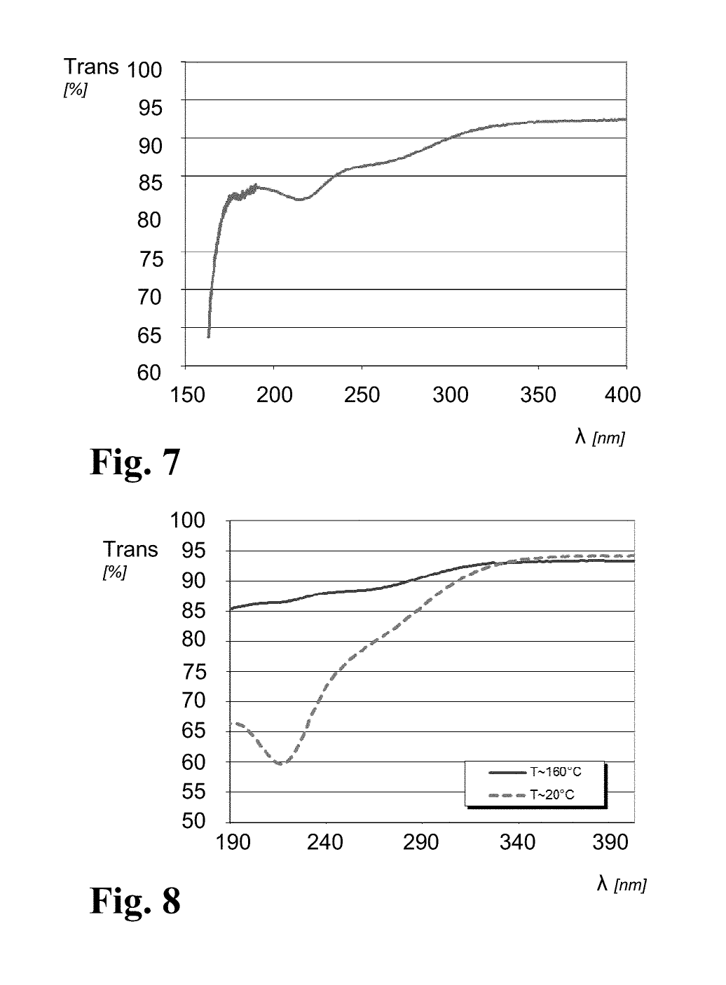

The transmission curve from FIG. 7 shows the transmission of a quartz glass plate made of highly pure, synthetic quartz glass with a thickness of 1 mm after irradiation with UV radiation at a quartz glass temperature of 40° C. Due to the irradiation, a colour centre that absorbs, in particular, high-energy radiation has been produced in the quartz glass plate.

FIG. 8 shows a comparison of two transmission spectra of quartz glass plates made of highly pure, synthetic quartz glass after irradiation at a quartz glass temperature of 20° C. versus 160° C. for a period of 1000 hours.

It is evident that strong cooling leads to a higher defect concentration and therefore consecutively to a reduced VUV irradiation intensity and a short useful life.

Although the invention is illustrated and described herein with reference to specific embodiments, the invention is not intended to be limited to the details shown. Rather, various modifications may be made in the details within the scope and range of equivalents of the claims and without departing from the invention.

1. A method for operating a xenon excimer lamp, the xenon excimer lamp including an exit window made of quartz glass, the method comprising the steps of:
(a) operating the xenon excimer lamp at an irradiation intensity of more than 80 mW/cm²; and
(b) temperature-controlling the xenon excimer lamp to an operating temperature in the range of 181° C. to 199° C.

2. The method of claim 1, wherein the xenon excimer lamp is temperature-controlled to the operating temperature in a range of 195° C. to 199° C.

3. The method of claim 1, wherein the xenon excimer lamp is operated at an irradiation intensity in a range of 85 mW/cm² to 125 mW/cm².

4. The method of claim 1 wherein, for temperature-control of the xenon excimer lamp, a temperature control unit is provided that determines an actual value of the operating temperature, compares the actual value of the operating temperature to a nominal value of the operating temperature, and issues a control signal to the temperature control unit in order to adjust a cooling/heating power of the temperature control unit.

5. The method of claim 1 wherein the temperature controlling of step (b) takes place by means of a fan.

6. The method of claim 1 wherein the xenon excimer lamp includes a lamp tube, wherein the exit window limits a discharge space and the lamp tube includes a rear-side lamp tube surface opposite from the exit window, wherein step (b) takes place by means of a fluid that is guided over the rear-side lamp tube surface.

7. The method of claim 6 wherein the fluid is water.

8. The method of claim 1 wherein the exit window has an exit window thickness in the range of 1 mm to 2 mm.

9. A lamp system, comprising:
a xenon excimer lamp including an exit window made of quartz glass;
a temperature control unit for adjusting an operating temperature of the xenon excimer lamp, whereby the xenon excimer lamp is designed for operation at an irradiation intensity of more than 80 mW/cm², wherein the temperature control unit is designed appropriately such that it controls the temperature of the xenon excimer lamp to an operating temperature in a range of 181° C. to 199° C.

10. The method of claim 2, wherein the xenon excimer lamp is operated at an irradiation intensity in a range of 85 mW/cm² to 125 mW/cm².

11. The method of claim 2 wherein, for temperature-control of the xenon excimer lamp, a temperature control unit is provided that determines an actual value of the operating temperature, compares the actual value of the operating temperature to a nominal value of the operating temperature, and issues a control signal to the temperature control unit in order to adjust a cooling/heating power of the temperature control unit.

12. The method of claim 3 wherein, for temperature-control of the xenon excimer lamp, a temperature control unit is provided that determines an actual value of the operating temperature, compares the actual value of the operating temperature to a nominal value of the operating temperature, and issues a control signal to the temperature control unit in order to adjust a cooling/heating power of the temperature control unit.

13. The method of claim 2 wherein the temperature controlling of step (b) takes place by means of a fan.

14. The method of claim 3 wherein the temperature controlling of step (b) takes place by means of a fan.

15. The method of claim 4 wherein the temperature controlling of step (b) takes place by means of a fan.

16. The method of claim 2 wherein the xenon excimer lamp includes a lamp tube, wherein the exit window limits a discharge space and the lamp tube includes a rear-side lamp tube surface opposite from the exit window, wherein step (b) takes place by means of a fluid guided over the rear-side lamp tube surface.

17. The method of claim 3 wherein the xenon excimer lamp includes a lamp tube, wherein the exit window limits a discharge space and the lamp tube includes a rear-side lamp tube surface opposite from the exit window, wherein step (b) takes place by means of a fluid guided over the rear-side lamp tube surface.

18. The method of claim 4 wherein the xenon excimer lamp includes a lamp tube, wherein the exit window limits a discharge space and the lamp tube includes a rear-side lamp tube surface opposite from the exit window, wherein step (b) takes place by means of a fluid guided over the rear-side lamp tube surface.

19. The method of claim 5 wherein the xenon excimer lamp includes a lamp tube, wherein the exit window limits a discharge space and the lamp tube includes a rear-side lamp tube surface opposite from the exit window, wherein step (b) takes place by means of a fluid guided over the rear-side lamp tube surface.

20. The method of claim 2 wherein the exit window has an exit window thickness in the range of 1 mm to 2 mm.
